(19) United States
(12) Patent Application Publication
(10) Pub. No.: US 2004/0146248 A1
(43) Pub. Date: Jul. 29, 2004

(54) Integrated optic modules using embedded fibers and processes of fabrication thereof

(76) Inventor: John Hong, Thousand Oaks, CA (US)

Correspondence Address: ROCKWELL SCIENTIFIC COMPANY LLC, Mail Code A15, P.O. Box 1085, Thousand Oaks, CA, 91358-0085, US

(21) Appl. No.: 10/352,548

(22) Filed: Jan. 28, 2003

(51) Int. Cl. G02B 6/30; G02B 6/26

(52) U.S. Cl. 385/49; 385/27

(57) ABSTRACT

In at least one embodiment, the invention is an optical module including a substrate having a channel, an optical fiber received in the channel having an exposed core, an operational device positioned so to be in optical communication with the exposed core and an insulation layer positioned over the operational device. The module is capable of transmitting a signal between the fiber and the core, such that any loss of signal power during the transmission is low. The operational device is capable of conditioning a signal carried by the optical fiber. The operational device can be an electrooptical polymer, a photopolymer, a sensor or other apparatus. In at least one embodiment, the invention includes a method of obtaining a substrate, defining a channel in the substrate, positioning a fiber with a core in the channel, exposing the core of the fiber and depositing an operational device over the exposed core.

### BACKGROUND

Although fabricated integrated optical circuits have provided many advantages, including that both the materials and structures used are optimized towards maximizing performance, the optical fiber and waveguide transitions continue to limit the overall performance of the circuit. That is, integrated optical circuits suffer from excess loss in the fiber to chip and chip to fiber launch points.

To allow certain functions to be performed on signals carried by optical fibers, prior devices have been arranged with fibers positioned to terminate at microchips. The microchips have imbedded components for performing various operations upon the signal transmitted from the fiber. In some devices, after manipulating the input signal, an output signal is transmitted from the chip to another attached fiber.

Typically, as shown in FIGS. 1A and B, a fiber/substrate structure 10 will have a microchip or substrate 30 with a waveguide 32 for receiving and/or transmitting a signal to or from an optical fiber 20 (shown in cut-away). Components for performing the desired operations to the signal are set within the waveguide 32. Because the substrate 30 is constructed in a vertical layered manner using techniques such as photolithography and etching processes, the waveguide 32 has a rectangular profile at the point of contact with the optical fiber 20.

In direct contrast to the profile of the waveguide 32, the optical fiber 20 has a round core 24, which carries the signal and a round cladding 22 positioned about the core 24. As a result, at a transition or coupling point 40 between the fiber core 24 and the waveguide 32, a profile mis-match exists. Because the round fiber core 24 and the rectangular waveguide 32 do not have matching profiles, a portion of the transmitted signal is lost at the interface. As the signal is transmitted from the fiber core 24, the portions of the signal which are not aligned with the waveguide 32 are lost as they contact the surrounding surface of the substrate.

Because a portion of the signal is lost at a fiber/waveguide interface 40, the overall signal strength is reduced at each fiber to chip and chip to fiber launch point. Reducing the signal strength can reduce the signal quality, reduce the transmission distance and require the signal to be boosted more often. As a result the overall system costs can be significantly increased.

Another problem is that during fabrication of the optical circuit, the fiber core 24 and the waveguide 32 must be precisely aligned to allow proper communication between the two. Improper core/waveguide alignment can result in significant power losses or even complete signal loss. The need for such precise alignment increases the production cost and time and can result in low production yields.

Therefore, what is needed is an interface or module which allows transmission of light to and from an optical fiber, into and out of a device with a minimum of power loss. Further, a method of fabrication is needed to produce an interface or module with lower fabrication and packaging costs and time, as well as higher yields.

### SUMMARY

The present invention provides an apparatus and a method of fabricating the apparatus. In one embodiment, the Applicant's invention is an optical module which includes a substrate having a channel, an optical fiber received in the channel having an exposed core, and an operational device positioned so to be in optical communication with the exposed core. The substrate can have an upper surface and the core an upper section. The core upper section can be substantially aligned with the upper surface of the substrate. Also, the core can be substantially aligned along the channel. The optical module can include an insulation layer which is positioned over the operational device to protect it from damage caused by shorting and/or physical contact.

In at least some embodiments the module is a low signal loss module. This module is capable of transmitting a signal between the core and the operational device, such that any loss of signal power during the transmission is low. That is, the operational device is in low signal loss optical communication with the core. Among other things, the operational device can be capable of either conditioning a signal carried by the optical fiber, sensing a signal, receiving a signal and/or transmitting a signal.

The operational device can be an active or a passive device. One such active device is an electrooptical polymer, which has a variable index of refraction. The index of refraction of the electrooptical polymer is variable as a function of a voltage applied across it. A passive operational device can be a photopolymer having at least two sections separated by a distance. The separation distance is defined so to limit passage of predefined wavelengths of light through the optical module. The separate sections each include a reflecting surface to cause the light of the defined wavelengths to be directed back down the optical fiber.

The method of the present invention includes the steps of obtaining a substrate, defining a channel in the substrate, positioning a fiber with a core in the channel, exposing the core of the fiber to create an exposed portion of the core and depositing an operational device. The operational device is positioned so to be in optical communication with the exposed portion of the core. The method can also include the step of applying an insulation layer over the operational device.

The steps of defining the channel in the substrate and exposing the core of the fiber can be performed by photolithography and etching processes. The optical fiber can include a cladding positioned about the core and the step of exposing the core of the fiber can involve etching an upper portion of the cladding to expose an upper area of the core. The step of positioning the fiber in the channel can include aligning the fiber substantially with the channel and applying an adhesive to secure the fiber to the substrate.

### BRIEF SUMMARY OF THE DRAWINGS

FIGS. 1A and B are cut away views of a fiber-to-chip interface.

FIGS. 2A-H are isometric views of portions of an optical module in accordance with the present invention.

FIG. 3A is an isometric view of an optical module in accordance with the present invention.

FIG. 3B is a overhead view of an optical circuit in accordance with the present invention.

FIG. 4A is an isometric view of an optical module in accordance with the present invention.

FIG. 4B is a cross-section view of an optical module in accordance with the present invention.

FIGS. 5A-G are flow charts of methods of fabrication in accordance with embodiments of the present invention.

### DETAILED DESCRIPTION

The present invention provides apparatuses which eliminate the need for a potentially high loss interface between an optical fiber and a waveguide. In particular embodiments, the apparatus eliminates the high loss interface by configuring the optical fiber to allow certain functions to be performed directly on the fiber and not within a separate waveguide. Namely, the apparatus allows operations, such as signal conditioning (e.g. modulation, filtering, isolation, etc.), which in prior devices was done within an attached waveguide, to instead, be accomplished directly on the fiber. As such, the apparatus of the invention provides for the application of operational devices (e.g. photopolymers, electrooptical polymers, sensors, etc.) to be placed directly on the optical fiber and not within an attached waveguide.

By avoiding the use of a waveguide, the Applicant's invention likewise avoids the signal losses inherent in an interface between an optical fiber and a waveguide. Also, fabrication is simplified as precision alignment of the fiber to the waveguide is no longer performed.

The present invention also provides methods of fabrication which provide for the construction of devices on the optical fiber itself. Such methods reduce production cost and time, as well as increase the overall production yield of the devices.

### Elimination of Fiber/Waveguide Interface

The Applicant's invention avoids the prior problems of high signal losses by entirely eliminating the lossy interface between an optical fiber and a waveguide. This is done by allowing the functions previously performed within the waveguide to be done directly on the fiber. The result is a simpler device with greatly reduced signal losses, which also is quicker and easier to fabricate.

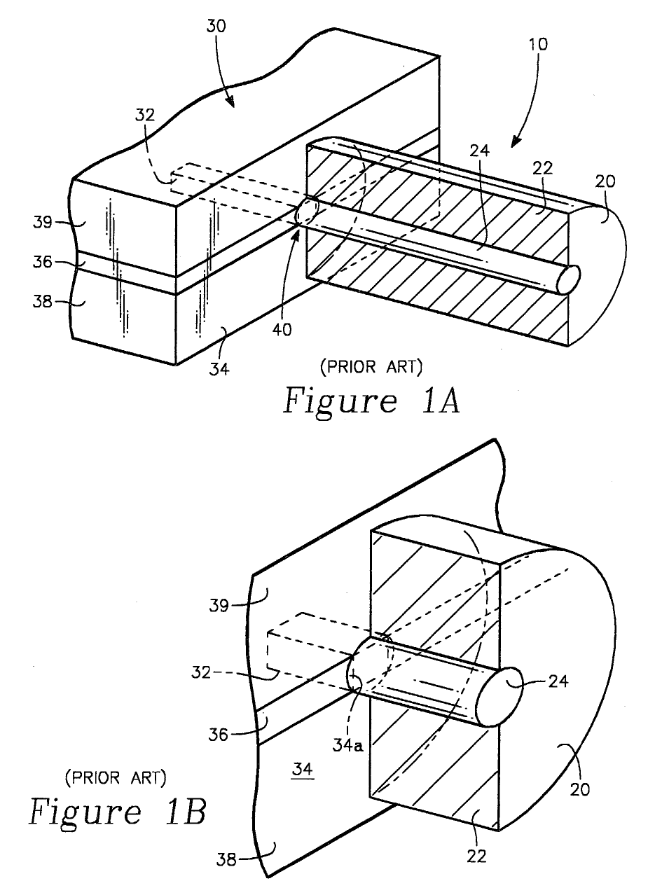

To improve the overall performance of integrated optical circuits, the present invention avoids the optical fiber and waveguide transitions (e.g. fiber to chip and chip to fiber launch points) inherent in prior devices. One example of such a lossy fiber-to-chip transition is the prior device shown in FIGS. 1A and B.

Prior Device with a Fiber/Waveguide Interface:

As shown in FIG. 1A, the fiber/substrate interface structure 10 loses a significant portion of the signal transmitted from the fiber core 24 to the waveguide 32. This signal loss is a result of the inherent mis-match of the shapes of the round core 24 and the square waveguide 32. The portion of the signal transmitted from the section of the core 24 which is not directly aligned with the waveguide 32, is lost as it contacts the front face 34 of the substrate 30, as shown in FIG. 1B. Additional signal loss can result from a misalignment of the core 24 and the waveguide 32, which causes an even greater portion of the signal to contact the face 34 and not be transmitted into the waveguide 32.

As shown in FIGS. 1A and B, the fiber 20 (shown in cut-away views) is positioned such that its end 26 abuts directly against the waveguide 32 at the transition 40. In this manner, the light (signal) carried by the core 24 can be transmitted into the waveguide 32. Likewise, light which is projected from the waveguide 32 is received by the core 24 for further transmission. As shown, the waveguide 32 has a square or rectangular cross-section which is created during the fabrication of the substrate 30, that the waveguide 32 is embedded within. The waveguide 32 is positioned in an optically active guiding layer 36 which is surrounded by a lower cladding layer 38 and an upper cladding layer 39.

In contrast to the shape of the waveguide 32, the core 24 has a circularly symmetric mode profile. As such, the light launched from a circular mode profile must be coupled into the waveguide 32 with a rectangular mode profile. Also, the waveguide 32 cross-section is smaller than the core 24 cross-section. For example, the interface structure 10 can have a core 24 with a diameter of between 5 and 10 μm (some embodiments 8-12 μm), and a waveguide 32 which is only between 3 to 6 μm square.

The differences between the profiles of the waveguide 32 and the core 24 at the transition 40, causes a certain amount of the light to be lost during its transmission between the waveguide 32 and the core 24. While the interface structure could be configured such that the waveguide is larger than the fiber core (structure not shown), losses would still occur during signal transmission from the waveguide to the core.

As noted, some or all the signal can also be lost due to simple misalignment of the waveguide 32 and the core 24. With the typical sizes of both the waveguide 32 and the core 24 being in the microns, the tolerances for positioning the two structures are in the sub-microns. An additional problem is that the fiber can move over time away from its original position adding to the misalignment problem.

Signal power loss can also result from the waveguide 32 and the core 24 being made of different materials which have different indexes of refraction. Such differences in the indexes can cause light to be reflected back in the direction which it was transmitted. For devices having more than one fiber/waveguide interface (e.g. an input and an output port) the total power loss can be multiplied several times.

Present Invention without a Fiber/Waveguide Interface:

In contrast to the prior devices, the present invention allows access to the signal in the fiber, and signal conditioning directly on the fiber, without the use of a waveguide connected by a high-loss interface.

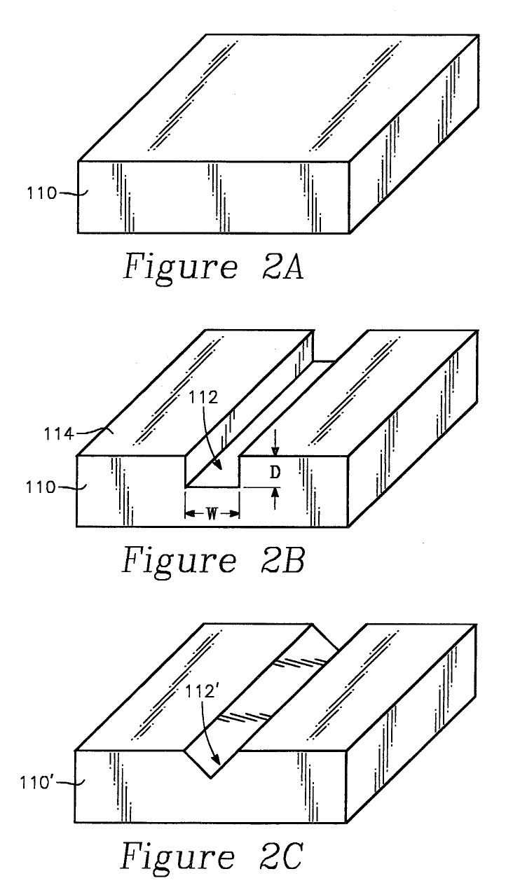

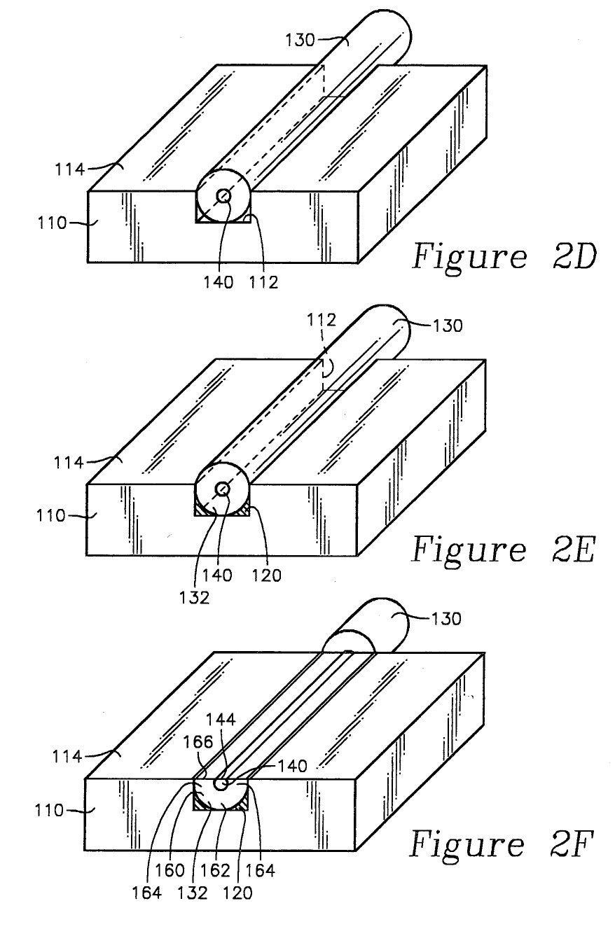

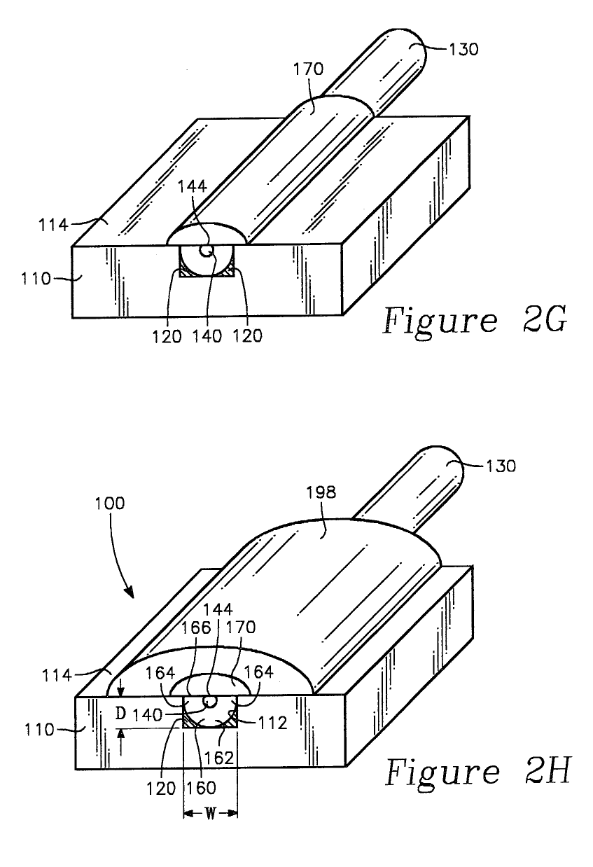

An embodiment of the present invention is shown in FIG. 2H. As can be seen, the integrated optics module 100 includes a substrate 110, an adhesive 120, a fiber 130, a fiber core or guide 140, a composite cladding 150, an operational device 170 and an insulating layer 198. The fiber 130 is positioned in and along a channel 112 of the substrate 110. The fiber 130 has a portion of the core 140 exposed running along the length of the fiber 130 defining an upper surface 144. The upper surface 144 is arranged to abut the device 170 to allow transmission of signals between the the core 140 and the device 170. As a result the signal in the fiber can be accessed by the device 170. As noted in more detail below, the operational device 170 can be any of a variety of specific materials, examples including an electrooptical polymer, a photopolymer, and Faraday materials.

With the fiber core 140 exposed to allow access to the signal transmitted in the fiber 130, the Applicant's invention allows operations to be performed directly on the fiber 130. This completely eliminates the need for a separate waveguide (not shown) to be attached to the fiber 130 by a high-loss interface (not shown). With the operational device 170 positioned directly on the exposed core 140, operations such as signal conditioning, can be performed with a minimum (if any) signal loss.

The present invention avoids the fiber/waveguide mis-match found in prior devices by having the operational device 170 placed directly onto the exposed portion of the core 140. In this manner the device 170 and the core upper surface 144 can be sized to closely match one another, preventing signal lost due to a portion of the signal contacting an interfering surface (such as the front face 34 of the substrate 30 in the prior device of FIGS. 1A and B). As set forth in greater detail herein, with the fabrication of the present invention employing photolithography and etching techniques, provides a degree of high precision in the sizing and alignment of the device 170 with the core upper surface 144.

As a result, the present invention avoids the need for the precise fiber/waveguide alignment inherent in the assembly of prior devices (as noted herein). Elimination of the need for fiber/waveguide alignment greatly reduces the fabrication expense and time, and by avoiding misaligned inoperable devices, the production yield is increased.

In addition, since the operational device is positioned directly upon the core 140 of the fiber 130, there is no need to transfer the signal between materials having different indexes of refraction (e.g. between the core and waveguide as shown in FIGS. 1A and B). This reduces power loss caused by reflection of the signal at the point of change in the index of refraction.

The embodiment of the present invention shown in FIG. 2H includes the substrate 110, the adhesive 120, the fiber 130, the core 140, the cladding 160, the operational device 170 and the insulating layer 198.

The substrate 110 can be any of a variety of suitable materials, including glass, rigid plastic, semiconductor materials, silicon, single-crystal silicon, gallium arsenide and alumina. The substrate can be a single or multiple layers of material.

In some embodiments the substrate 110 has a thickness of about 0.5 mm. The thickness of the substrate must be at least great enough to allow it to retain a portion of an optical fiber (in certain embodiments this minimum thickness would be greater than the about 72.5 μm thickness of a fiber with an exposed core). The material and the thicknesses used should provide at least sufficient rigidity and strength to the substrate so that it will properly support the fiber and structures deposited thereon, as noted in further detail below.

The substrate 110 includes the channel or groove 112 which functions to receive and retain the fiber 130. The size of the channel 112, the width W and depth D, can vary as needed for each embodiment. However, in embodiments such as that shown in FIG. 2H, the channel 112 is sized to receive at least a portion of the fiber 130. For example, in at least one embodiment, the channel 112 is rectangular in shape and is about 70 μm deep and 125 μm wide. The channel 112 has a depth that allows for the fiber core to be positioned just above the substrate surface 114. While a rectangular shape is shown, the specific shape of the channel 112 can vary depending on the requirements of the particular embodiment.

In embodiments such as that shown in FIG. 2H, the fiber 130 can be a telecom grade optical fiber which has had its external coating stripped away to expose the cladding 160.

The fiber 130 is secured in the channel 112 by an adhesive 120 which bonds the fiber 130 to the substrate 110. In some embodiments, the fiber 130 is potted into the substrate 110 with a solder and/or an epoxy 120. A variety of solders and/or epoxies can be used, including silver solder and the like. In embodiments employing a glass for the substrate 110, a solder (metal) can be used to bond a glass fiber 130 to the glass substrate 110.

It should be noted that the fiber 130 is shown in FIG. 2h (and other figures as well) as ending at the front face of the substrate 110, in some embodiments the fiber 130 continues on past the substrate 110.

As can be seen in FIG. 2H, an upper portion of the cladding of the fiber 130 has been removed during fabrication (as described in detail below). The removal of the upper portion of the cladding 160 exposes at least a portion of the core 140 and leaves the side portions 164 and a lower portion of the cladding 162. The sides 164 of the cladding 160 have flat upper areas 166.

A flat upper surface 144 of the core 140 is created by the removal of the upper portions of the cladding 160 and of the core 140. The amount of the core 140 which is exposed, that is the size of the surface 144, can vary depending on the embodiment of the invention. Specifically, the size of the upper surface 144 can vary as needed by the particular device 170 deposited over the core 140. In this manner the exposed upper surface 144 can be tailored to exactly match the requirements of the device 170, eliminating the size mis-matches, and associated power losses, found in prior devices (such as that shown in FIGS. 1A and B).

As shown in the embodiment of FIG. 2H, the operational device 170 is positioned over both the substrate 110 and the fiber 130. With the device 170 abutting the exposed upper surface 144 of the core 140, signals can be transmitted therebetween. This provides a low loss interface between the fiber 130 and the device 170. As set forth in further detail herein, the device 170 can be a variety of apparatuses including electrooptic modulators, signal filters, isolators, sensors, signal receivers and transmitters. Materials which can be used in the device 170 include electrooptical polymers, photopolymers, Faraday materials, sensor materials, and the like.

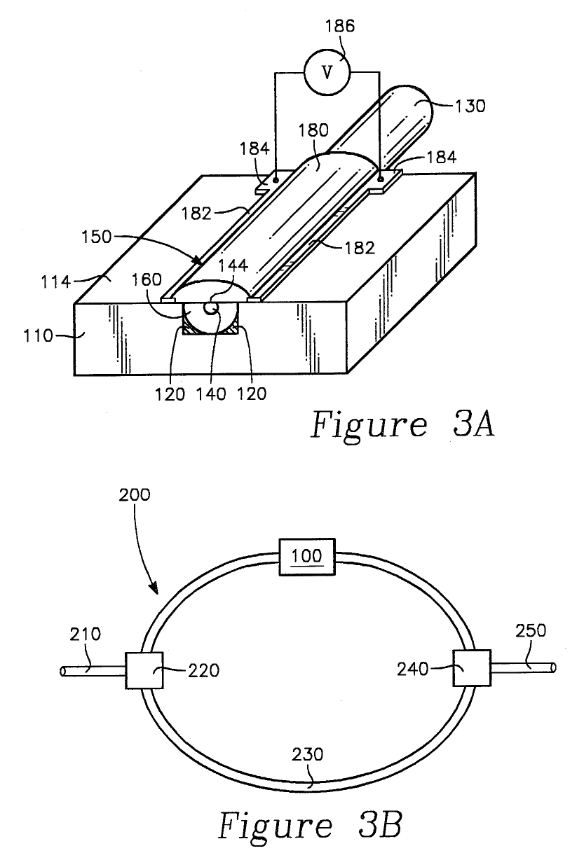

To control, monitor and/or power the device 170, lead lines (not shown in FIG. 2H) can be applied over or within the substrate 110 and/or the device 170, as well as upon the fiber 130. An embodiment of the present invention employing such lead lines is set forth in FIG. 3A.

To package and protect the operational device 170 and surrounding structures, the insulating layer 198 is positioned over the device 170. The insulating layer 198 also can extend over portions of the substrate 110, fiber 130 and any lead lines or other structures. The insulation layer 198 functions to protect the components it covers from damage which could otherwise be caused by electrical shorting and/or physical contact. The insulation layer 198 can be made of a variety of materials including glass, plastic, dielectrics (e.g. silicon nitride) and/or a polyimide. The thickness of the insulation layer 198 can vary by the requirements of the specific application of the embodiment and by the particular material employed. However, typically the layer 198 is sufficiently thick to prevent damage to the device 170 and substrate 110 from external effects which could cause shorting or direct physical damage.

### On-Fiber Signal Conditioning

In the present invention, signal conditioning (e.g. modulation, filtering, detection, etc.) is performed directly on the optical fiber, and not within a separate waveguide. By eliminating the need for attachment of the optical fiber to a waveguide, the present invention avoids the high signal loss associated with fiber/waveguide interfaces.

As noted herein and shown in FIG. 2H, the integrated optics module 100 includes the operational device 170 for accessing and conditioning the signal directly on the fiber. Depending on the embodiment of the invention, the device 170 can be any of a variety of apparatuses including: signal conditioners, sensors, detectors, transmitters, receivers and the like. Signal conditioners can be devices such as an electrooptical polymer and/or a photopolymer. In some embodiments an electrooptical polymer is used to allow the fiber signal strength to be varied. Likewise a photopolymer can be employed to filter certain wavelengths of the fiber signal.

As shown in the embodiment of FIG. 3A, the operational device 170 is an electrooptical polymer 180. The electrooptical polymer 180 is positioned upon the substrate 110, the cladding 160 and the core 140. The electrooptical polymer 180 functions to provide electrooptic modulator applications. The electrooptical polymer 180 is configured with leads 182, contacts 184 and a voltage source 186, which allows a voltage, V, to be applied across the electrooptical polymer 180. The application of the voltage, V, causes the index of refraction of the electrooptical polymer 180 to change (as described in further detail below). Because the core 140 of the fiber 130 is exposed at the upper surface 144, where core 140 abuts the electrooptical polymer 180, light traveling in the core 140 can pass from the core 140 into the electrooptical polymer 180. This allows the electrooptical polymer 180 to operate as an electrooptic modulator (as described in further detail below).

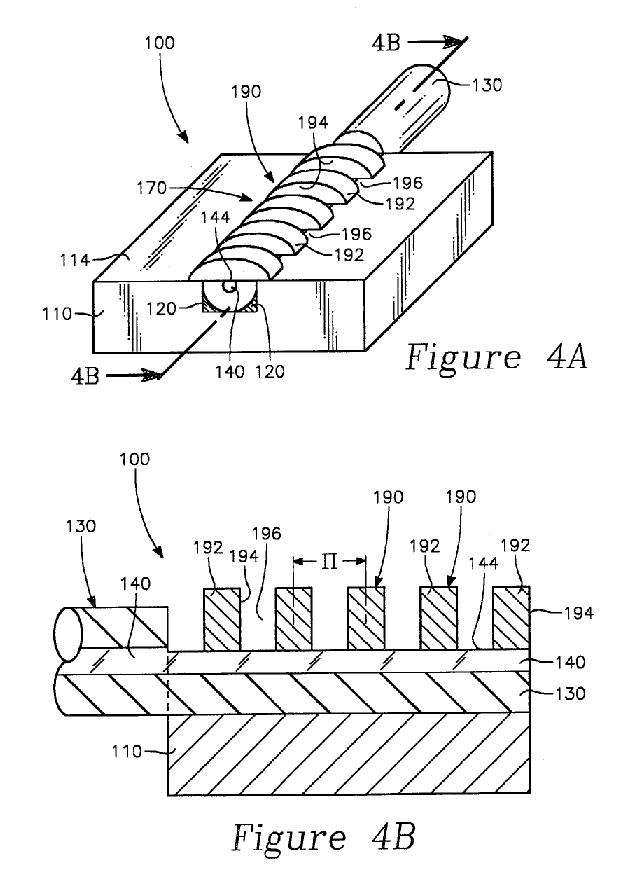

As shown in FIGS. 4A and B, in another embodiment of the present invention, the operational device 170 is a photopolymer 190. The photopolymer 190 is employed for passive grating applications, that is, it filters out undesired light wavelengths from the light passing through the fiber 130. The photopolymer 190 is physically shaped to have a structure which causes light of certain wavelengths to be reflected back down the fiber 130 and not out through the module 100. At the same time, the photopolymer 190 does not prevent passage through the module 100 of light having wavelengths outside of the blocked wavelength range.

The photopolymer 190 is positioned over the substrate 110, the cladding 160 and the exposed core 140. In this position, light travels from the core 140 through the core upper surface 144 and into the photopolymer 190. As can be seen, the photopolymer 190 is divided into segments 192 which are spaced apart by gaps 196. The segments 192 have vertical walls 194, which provide a surface for the light entering the photopolymer 190 to reflect off of. The specific wavelengths of the light to be filtered by the photopolymer 190 is determined by the spacing, Λ, between the segments 192 (as described in further detail below). Allowing each embodiment of the module 100 to be specifically tailored to match the light wavelength to be filtered.

Sensors and Other Optical Devices:

Any of a variety of sensors, detectors, transmitters and other devices, can also be deposited above the exposed portion of the fiber core 140. Such devices can include signal wavelength sensors, signal strength sensors, temperature sensors, signal emitters (e.g. lasers), signal receivers, multiplexers, demultiplexers, switches and/or the like.

One embodiment of the present invention includes a thermal sensor. The thermal sensor functions to change the characteristics of the light transferring through the device to correspond to a change in the temperature of the device. Such an embodiment can be used in a heat sink application.

As detailed herein, a sensor can be deposited over the substrate 110, cladding 160 and/or the core 140 by the methods set forth herein (e.g. method 352).

### Methods of On-Fiber Signal Conditioning

The present invention can employ a variety of methods to condition signals directly on the optical fiber. As noted, this eliminates the need for a separate waveguide which, in prior devices, was attached to the fiber by a high loss interface.

Methods of on-fiber signal conditioning can include: signal modulation, filtering, isolation and detection. Specific examples of on-fiber signal conditioning include electrooptic modulation, passive grating and signal isolation.

Electrooptic Modulation Methods:

As noted in detail herein, in some embodiments of the present invention, an electrooptical polymer is positioned over, and in communication with, an exposed fiber core. The electrooptical polymer functions to provide electrooptic modulation of optical fiber signals. The electrooptic modulator can change either the phase of the light in the signal or it can change the intensity of the light. By splitting a signal and directing one portion through a combined fiber core and electrooptical polymer structure with a variable index of refraction, and sending the other portion of the signal through a structure (e.g. optical fiber) having a constant index of refraction, a recombined signal can be modulated by varying the index of refraction of the fiber/polymer structure.

As shown in FIG. 3A, one embodiment of the present invention includes the electrooptical polymer 180 (as the operational device 170), position over the substrate 110, fiber 130 and the exposed fiber core 140. The electrooptical polymer 180 is configured with leads 182, contacts 184 and a voltage source 186, allowing a voltage, V, to be applied across the electrooptical polymer 180. Applying a voltage across the polymer 180 causes a static electric field to be generated. The index of refraction of the polymer 180 varies as a function of the voltage.

The application of the voltage causes the index of refraction of the electrooptical polymer 180 to change. This ability to change its material properties by application of a voltage makes the electrooptical polymer 180 an active device. Because the core 140 of the fiber 130 is exposed at the upper surface 144, where core 140 abuts the electrooptical polymer 180, light traveling in the core 140 can pass from the core 140 into the electrooptical polymer 180.

The integrated optics module has the fiber core 140 surrounded by the composite cladding 150. The composite cladding 150 includes the original fiber cladding 160 and the applied electrooptical polymer 180. The core 140 has a guiding index of refraction, n_{g}, and the composite cladding 150 has an index of refraction, n_{c}. The electrooptical polymer 180 has an index of refraction, n_{c1}, and the original fiber cladding 160 has an index of refraction of, n_{c2}.

To allow guiding of a signal (e.g. a guiding condition) through the core 140, the index of refraction, n_{g}, should be larger than both the index of the polymer 180, n_{c1}, and the index of the cladding 160, n_{c2}. However, the arrangement of n_{c1} to n_{c2} can be made asymmetric (e.g. n_{c2}>n_{c1}, or n_{c1}>n_{c2}).

By changing the index of refraction, n_{c1}, of the electrooptical polymer 180, as a result of varying the voltage, V, passed through the electrooptical polymer 180, the amount of light which passes from the core 140 into the electrooptical polymer 180 can be varied. This is because the index of refraction, n_{g}, of the core 140 and the index of refraction, n_{c1}, of the electrooptical polymer 180 can vary relative to one another. The index of refraction, n_{c1}, varies as a function of the voltage applied to the polymer 180:

n_{c1}∝\vec{E}_{APPLIED}

By varying the index of refraction, n_{c1}, of the electrooptical polymer 180, to be significantly larger than the index of refraction, n_{g}, of the core 140, then substantially all the light from the core 140 will pass into the cladding 150. This allows the light in the core 140 to be turned off. The light in the core 140 can then be turned back on by changing the voltage across the polymer 180 such that n_{g} is larger than n_{c1}.

Varying the index of refraction, n_{c1}, of the polymer 180 causes the index of refraction, n_{c}, of the entire composite cladding 150 to change. Since the effective index of refraction, n_{eff}, of the integrated optics module 100 is a function of the index of refraction, n_{g}, of the core 140 and the index of refraction, n_{c}, of the cladding 150, varying the index of the polymer 180 will directly affect the index of the module 100. This is noted in the following formula:

n_{eff}=f(n_{g}, n_{c})

Changing the effective index of refraction, n_{eff}, of the integrated optics module 100 causes the speed of light through the module 100 to vary. By positioning the module 100 in a circuit 200 as shown in FIG. 3B, varying the speed of light through the module 100, the intensity of the light at the output of the circuit 200 can be adjusted. The phase modulation can be changed into an intensity modulation by using the circuit 200 as an interferometer.

The circuit 200 includes the module 100, an input fiber 210, a beam splitter 220, a fixed fiber 230, a beam joiner 240 and an output fiber 250.

In at least some embodiments of the present invention, the input fiber 210, fixed fiber 230 and output fiber 250 are optical fibers having a core and a cladding, such as a fiber of telecom grade. Such fibers are well known to one skilled in the art.

Set between the input fiber 210, the fixed fiber 230 and the module 100 is the beam splitter 220. The beam splitter functions to split the light coming from the input fiber, such that some (e.g. half) of the light is sent to the fixed fiber 230 and some (e.g. half) is sent to the module 100. Beam splitters such as beam splitter 220 are well known to those skilled in the art. The fixed fiber 230 simply functions to transmit light from the beam splitter 220 to the beam joiner 240. The beam joiner 240 is a beam splitter which is set in a configuration generally reverse of the beam splitter 220. That is, the beam joiner 240 takes the outputs from the fixed fiber 230 and the module 100 and combines them into a single beam of light which is transmitted through the output fiber 250. In place of both the beam splitter 220 and the beam joiner 240, fiber splitters can be used.

As noted above in detail, the module 100 functions to vary the speed of the light passing through it. By varying the speed of the light passing through the module 100, the phase, φₘ, of the light is changed, relative to the phase, φ_{f}, of the light in the fixed fiber 230. With the light from the fixed fiber 230 being combined with the light from the module 100 in the beam joiner 240, varying the phase, φₘ, allows the intensity of the light exiting the beam joiner 240 (into the output fiber 250) to be varied. In fact, when the phase, φₘ, of the light from the module 100 is 180 degrees out of phase of the phase, φ_{f}, of light from the fixed fiber 230, the light beams will cancel each other out in the beam joiner 240 and no light will be transmitted from the circuit 200.

Therefore, varying the voltage, V, causes the index of refraction, n_{c}, of the cladding 150, to change, which in turn varies the speed of light in the module 100, resulting in the light entering the beam joiner to have different phases, φₘ and φ_{f}, and allowing the intensity of the light output from the circuit 200 to vary.

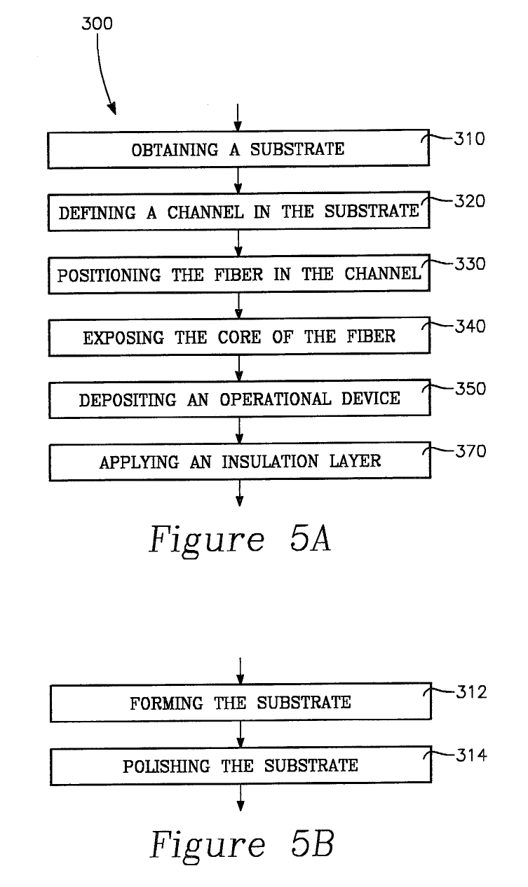

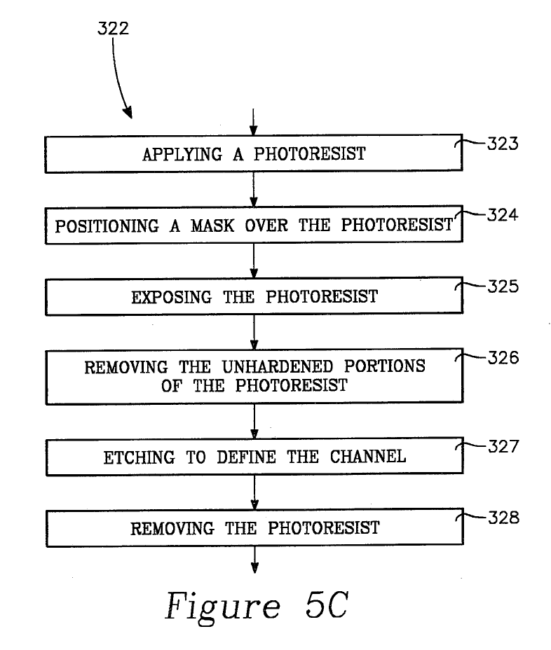

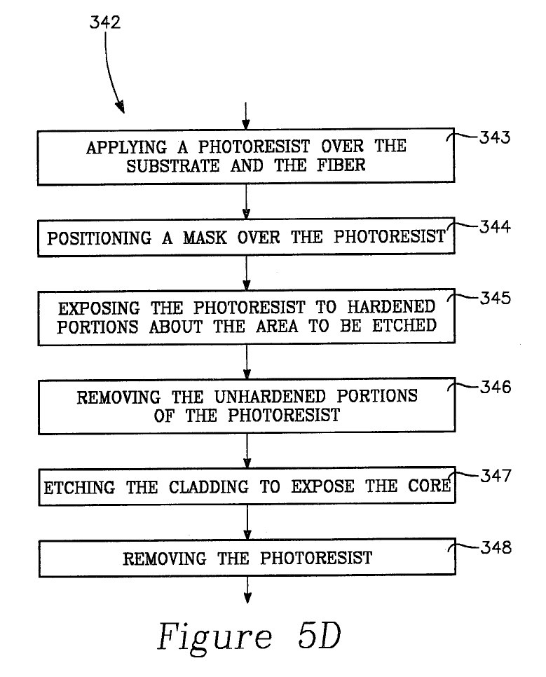

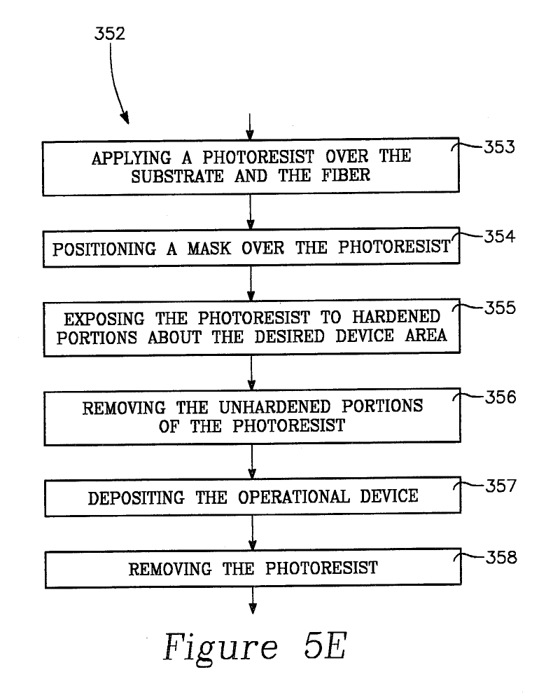

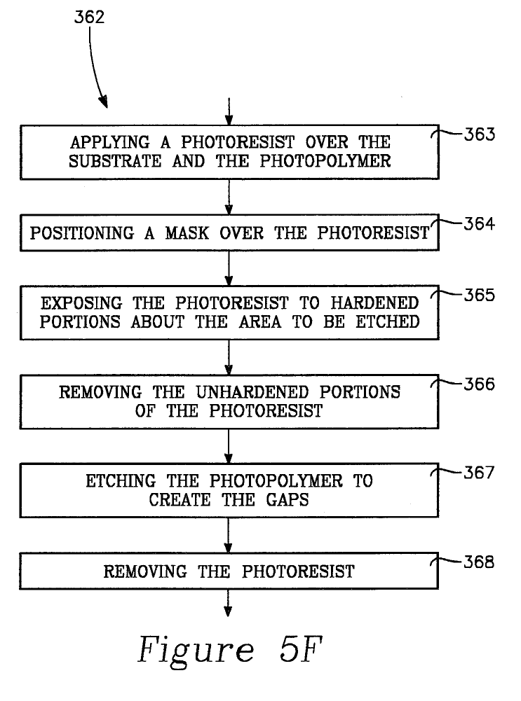

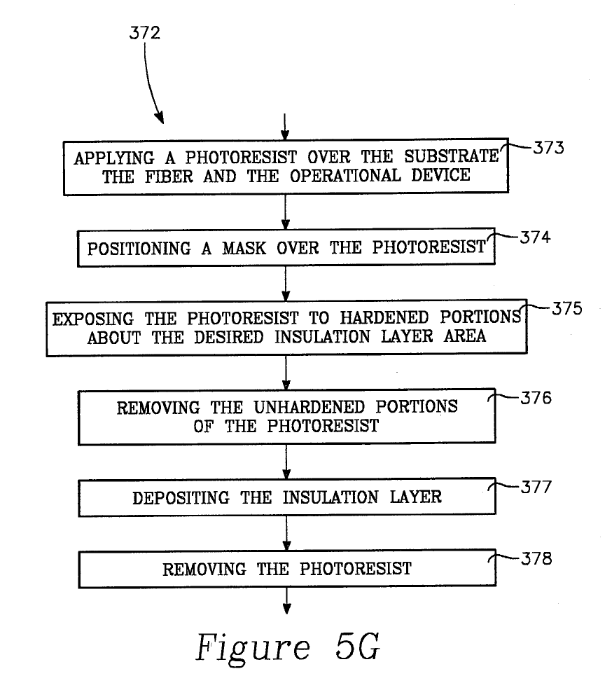

The electrooptical polymer 180 can be deposited by any of a variety of techniques well known to one skilled in the art, in some embodiments of the present invention the electrooptical polymer 180 is deposited by a photolithography method (such as method 352 set forth in FIG. 5E), as detailed herein.

Passive Grating Methods:

Another method of on-fiber signal conditioning is passive grating. Passive grating allows selective filtering of certain undesired wavelengths of light from an on-fiber signal.

As shown in FIGS. 4A and B, some embodiments of the present invention have a photopolymer 190 as the device 170. The photopolymer 190 is employed for passive grating applications by functioning to filter out undesired light wavelengths from the light passing through the fiber 130. In some embodiments the photopolymer 190 functions as a Bragg grating.

The photopolymer 190 is configured to limit passage of certain wavelengths of light through the module 100. The photopolymer 190 can be physically shaped to have a structure which causes light of certain wavelengths to be reflected back down the fiber 130 and thus not out through the module 100. At the same time, the photopolymer 190 does not prevent passage through the module 100 of light having wavelengths outside of the blocked wavelength range. Since the photopolymer 190 performs its functions without changing its material properties during operation (unlike the electrooptical polymer 180 detailed herein), the photopolymer 190 is a passive device.

In the embodiment shown in FIGS. 4A and B, the photopolymer 190 is positioned over the substrate 110, the cladding 160 and the exposed core 140. In this position, light travels from the core 140, through the core upper surface 144 and into the photopolymer 190. As can be seen, the photopolymer 190 is divided into segments or corrugations 192 which are spaced apart by gaps 196. That is, the photopolymer 190 is a periodic structure. The segments 192 have vertical walls 194, which provide a surface for the light entering the photopolymer 190 to reflect off of. The specific wavelengths of the light to be filtered by the photopolymer 190 is determined by the spacing or critical dimension, Λ, between the segments 192. The relationship between the spacing, Λ, is related to the wavelength, λ₀, of light which is to be filtered by the following formula:

Λ=λ₀/2 n

Where n is the index of refraction of the photopolymer 190. Therefore, as the wavelength, λ₀, of the light which is to filtered is changed, there is a proportional change in the distance, Λ, between the segments 192. This allows each embodiment of the module 100 to be specifically tailored to match the light wavelength to be filtered.

The photopolymer 190 can be fabricated in any of a variety of methods well known to those skilled in the art, including by a photolithography method for depositing the photopolymer 190 and a photolithography and etching method for creating the gaps 196 in the photopolymer 190. In some embodiments of the present invention the deposition and etching of the photopolymer 190 is done by a photolithography and etching methods (e.g. method 362 as detailed herein and as shown in FIG. 5F).

Signal Isolation Methods:

Another signal conditioning method of the present invention involves controlling the direction of travel of the signal in the fiber. In some embodiments, the device 170 is a signal isolator. The signal isolator functions to control the direction of the signal passage. That is, the signal isolator can allow the transmission of signals in the fiber optic 130 so that they travel in only one direction and prevent passage of the signal in the opposite direction. The signal isolator is comprised of a Faraday material and the input signal is polarized, such that the signal is allowed to pass in only one direction along the fiber.

### Fabrication Methods for Allowing On-Fiber Signal Access and Conditioning

The Applicant's invention also includes methods for fabrication of devices capable of accessing signals in an optical fiber and/or performing signal conditioning directly on the fiber.

Embodiments of the method of the present invention includes processes for fabricating integrated optics modules having operational devices. These operational devices can be configured for a variety of functions including electrooptic modulating, passive grating signal isolation and sensor applications. One embodiment of a fabrication method 300 includes the steps of obtaining a substrate 310, defining a channel in the substrate 320, positioning the fiber in the channel 330, exposing the core of the fiber 340, depositing an operational device 350, and applying an insulation layer 370, as shown in FIG. 5A.

The step of obtaining a substrate 310 includes preparing a substrate which can be used in the later steps of further fabricating the desired optics module. Specifically, among other things, the substrate must be of a suitable material, thickness, rigidity, strength and polish. As shown, in FIG. 5B, in some embodiments of the present invention, the step of obtaining a substrate 310 can further include the steps of forming the substrate 312 and polishing the substrate 314.

For the step of forming the substrate 312, depending on the particular material used, any of a variety of methods well known to one skilled in the art can be used to form the substrate. Likewise, a plastic substrate can be formed by any well known process such as injection molding, or the like.

After forming the substrate the step of polishing the substrate 314 is performed. During this step, the upper surface of the substrate is polished sufficiently to allow the later deposition of structures onto the substrate. That is, depending on the particular embodiment, the upper surface of the substrate should be polished to an extent that it has a roughness no greater than that which will allow an operational device and/or insulation (passivation) layer to be deposited upon the substrate. The substrate can be polished by any of a variety of well known methods, including a chemical mechanical polish (CMP) process, a mechanical polish and/or a chemical etch. A cross section of the polished substrate 110 is shown in FIG. 2A.

As shown in FIG. 5A, another step in the method 300 is defining a channel in the substrate 320. During this step a channel or groove 112 is defined in the substrate 110, as shown in FIG. 2B. As noted in further detail herein, the channel 112 functions to retain the fiber (not shown), so that further fabrication steps can be performed upon the fiber, including etching of the fiber and building structures upon fiber and the substrate 110.

Depending on the specific embodiment of the invention, the size (e.g. the width W and depth D) of the channel 112 can vary as needed. In some embodiments the size of the channel 112 is set so the channel can later receive at least a portion of an optical fiber (not shown). In one example, the channel 112 is rectangular in shape and is about 70 μm deep and 125 μm wide. The channel 112 has a depth that allows for the top of the fiber core to be positioned at or just above the substrate surface 114. In some embodiments the depth of the channel 112 is between about 70 and 72.5 μm. Further, the width of the channel 112 is sufficient to retain the fiber and keep it from being laterally displaced.

The shape of the channel 112 can also vary depending on the requirements of the specific embodiment. As shown in FIG. 2B, the channel 112 has a rectangular cross-section, which allows the channel 112 to receive a fiber (not shown) with a circular or semi-circular cross-section. One alternative cross-section for a channel 112′ is a v-shape, as shown in FIG. 2C. It should be clear to one skilled in the art that other shapes for the cross-section of the channel are possible. The channel can be shaped to specifically match the shape of the cross-section of the fiber it will receive.

Returning to FIG. 2B, the channel 112 can be created by any of a variety of methods including those well known to persons skilled in the art. The method used is in part dependent on the material used for the substrate 110. For example, for forming a channel 112 in a substrate 110 of a semiconductor or glass material, a process of photolithography and etching can be used. A wet or dry etch (e.g. reactive ion etch) can be employ to form the channel 112. Photolithography and etching processes are well known to those skilled in the art. One example of a photolithography and etching process to create a channel is a method 322 which includes the steps of applying a photoresist 323, positioning a mask over the photoresist 324, exposing the photoresist 325, removing the unhardened portions of the photoresist 326, etching to define the channel 327, and removing the photoresist 328. This process is shown in FIG. 5C.

In the applying step 323, a photoresist 116 is applied over the surface of the substrate 114. With the step of positioning the mask 324, a mask (not shown), which is arranged to define an area at the desired position of the channel, is used. The step of exposing the photoresist typically involves exposing those portions of the photoresist not covered by the mask (portions about the desired location of the channel) to a light source. Exposing the photoresist causes the areas of the photoresist about the defined location of the channel 112 to be hardened. After the photoresist has been exposed, the mask can be removed. The step of removing the unhardened portions of the photoresist is normally accomplished by applying a developer or a solvent. The result is that just the hardened portions of the photoresist, those about the desired location of the channel, remain. The surface 114 of the substrate 110 is thus exposed at the desired location of the channel. During the etching step 327, the surface 114 of the substrate 110 is etched down until the channel 112 is formed. Any of a variety of well known etching methods can be employed to etch the substrate. Such methods include dry etch, wet etch, reactive ion beam etching (RIE), ion milling and the like. The step of removing the photoresist 328 can be accomplished by any method well known in the art including using a stripper (with or without ultrasound) to dissolve and dislodge the photoresist materials.

Of course, those skilled in the art will recognize that the method of forming the channel 112 in a semiconductor or glass material can be accomplished in a variety of other processes well known in the art (for example, by use of a negative photoresist).

In contrast to semiconductor substrates, for a plastic or glass substrate 110, different fabrication processes can be used. One such process of defining a channel 112 in the plastic or glass substrate 110 is by injection molding. This process involves using a mold which is shaped to define the substrate 110 with the channel 112, injecting a liquid or deformable plastic or glass material into the mold, allowing the plastic or glass to harden and then removing the substrate 110 having the channel 112. As with a channel defined in the semiconductor material substrate, the channel 112 of the plastic or glass substrate 110, can be any of a variety of sizes and shapes to receive an optical fiber. In certain embodiments, the channel 112 is sized and shaped to receive a fiber 130 such that the top of the fiber core 140 is positioned just above the substrate surface 114, as shown in FIG. 2E. The use of injection molding allows for high throughput manufacturing and provides reduced fabrication costs.

Those skilled in the art will recognize that the method of forming the channel 112 in a plastic material, can be accomplished by a variety of processes well known in the art, other than the specific processes listed herein.

As shown in FIG. 5A, another step in the method 300 is positioning the fiber in the channel 330. During this step the fiber 130 is laid into the channel 112 and secured in place, as shown in FIGS. 2D and E. The fiber 130 can be secured by any of a variety of means, including the use of a physical structure to hold the fiber 130 by an interference fit with the substrate (between the channel 112 and fiber 130), the use of an adhesive 120 to bond the fiber 130 to the substrate 110 and/or by fusing or welding the fiber 130 to the substrate. While any of a variety of adhesives well known to one skilled in the art can be used, in at least one embodiment of the present invention the fiber 130 is potted into the substrate 110 with a solder and/or an epoxy 120.

As shown in FIG. 2E, the adhesive 120 (solder, epoxy or the like) is positioned between the fiber 130 and the substrate 110. While FIG. 2E shows an embodiment of the invention with the adhesive 120 positioned about the bottom 132 of the fiber 130, the adhesive 120 can also be positioned at other locations about the fiber 130, such that the adhesive 120 is located between the fiber 130 and the substrate 110.

It will be clear to one skilled in the art that the application of the adhesive 120 can be performed in a variety of ways and orders. Examples include applying the adhesive 120 to the channel 112 and then positioning the fiber 130 in the channel 112, applying the adhesive 120 to the fiber 130 and then positioning the fiber 130 in the channel 112, and positioning the fiber 130 in the channel 112 and then applying the adhesive 120.

Another step in the method 300 is exposing the core of the fiber 340, as shown in FIG. 5A. During this step a portion of the fiber 130 is removed to expose at least a portion of the core 140. One example of such removal is shown in FIG. 2F. As can be seen, an upper portion of the original insulation or cladding 160 is removed, leaving just side portions 164 and a lower portion of the cladding 162. The sides 164 of the cladding 160 having flat upper areas 166. At least some of the core 140 is also exposed. The amount of the upper section 142 of the core 140 which is exposed during this step can vary depending on the embodiment of the invention. The larger exposed area needed by the operational device (not shown in FIG. 2F), which will later be deposited over the core 140, the more of the core 140 which must be exposed. Removal of a portion of the upper section 142 of the core 140 creates a flat upper surface 144.

The exposure of the core 140 can be done by any of a variety of methods well known by those skilled in the art, including by a photolithography and etching process (dry or wet etch), or by a polishing or grinding down process. One example of a photolithography and etching process to expose the core 140 is a method 342 which includes the steps of applying a photoresist over the substrate and the fiber 343, positioning a mask over the photoresist 344, exposing the photoresist to hardened portions about the area to be etched 345, removing the unhardened portions of the photoresist 346, etching the cladding to expose the core 347, and removing the photoresist 348. This process is shown in FIG. 5D. Any of a variety of well known etching methods can be employed to etch the cladding. Such methods include dry etch, wet etch, reactive ion beam etching (RIE), ion milling and the like. For exposing the core 140 by polishing, an abrasive surface, such as a grinding wheel, can be used. In other embodiments of the present invention, a chemical mechanical polish (CMP) process is used. Applicable CMP processes are well known to those skilled in the art.

It should be clear to one skilled in art that in other embodiments of the present invention, the step of exposing the core of the fiber 240 can be performed prior to the step of positioning the fiber in the channel 230. That is, the core 140 can be exposed and then the fiber 130 can be positioned and secured in the channel 112 of the substrate 110.

As shown in FIG. 5A, another step in the method 300 is depositing an operational device 350. During this step, the operational device 170 is deposited over the upper surface 144 of the exposed core 140, as shown in FIG. 2G. As noted in more detail herein, the device 170 can be a variety of apparatuses including the electrooptical polymer 180, the photopolymer 190 (neither shown in FIG. 2F), a sensor, receiver, transmitter and/or the like.

In some embodiments of the present invention, the operational device 170 is deposited by a photolithographic method 352, as shown in FIG. 5E. In at least one embodiment, the method 352 includes the steps of applying a photoresist over the substrate and the fiber 353, positioning a mask over the photoresist 354 (wherein the mask defines the desired position of the device), exposing the photoresist to hardened portions about the desired device area 355, removing the unhardened portions of the photoresist 356, depositing the operational device 357, and removing the photoresist 358. The step of depositing the operational device 357 can be performed by any well known deposition technique, including sputtering, chemical vapor deposition (CVD), and the like.

Depending on the configuration of the device 170, the method 352 can be repeated to apply a variety of layers having different patterns. This allows specific structures such as lead lines and vias to be built over the exposed core 140, the cladding 160 and the substrate 110. One skilled in the art will recognized that other well known deposition techniques other than photolithography can also be applied to deposit the operational device 170.

With embodiments of the Applicant's invention which employ the electrooptical polymer 180 as device 170, the deposition of the electrooptical polymer 180 can be done by the method 352 as shown in FIG. 5E.

In embodiments where the photopolymer 190 is used as the device 170, the deposition of the material of photopolymer 190 can be done by the photolithography method 352 as detailed above. For the process of photolithography and etching to form the gaps 196, any of a variety of methods well known to those skilled in the art can be used including a method 362 which includes the steps of applying a photoresist over the substrate and the photopolymer 363, positioning a mask over the photoresist 364, exposing the photoresist to hardened portions about the area to be etched 365, removing the unhardened portions of the photoresist 366, etching the photopolymer to create the gaps 367, and removing the photoresist 368. This process is shown in FIG. 5F. Any of a variety of well known etching methods can be employed to etch the photopolymer. Such methods include dry etch, wet etch, reactive ion beam etching (RIE), ion milling and the like.

The next step in the method 300 is depositing an insulation layer 370, as shown in FIG. 5A. As shown in FIG. 2H an insulation layer or passivation layer 198 is positioned over the substrate 110, the fiber 130 and the device 170.

The insulation layer 198 can be deposited by any of a variety of methods well known in the art, including a photolithographic method 372, as shown in FIG. 5G. In at least one embodiment of the present invention the method 372 includes the steps of applying a photoresist over the substrate, the fiber and the operational device 373, positioning a mask over the photoresist 374 (wherein the mask defines the desired position of the insulation layer), exposing the photoresist to hardened portions about the desired insulation layer area 375, removing the unhardened portions of the photoresist 376, depositing the insulation layer 377, and removing the photoresist 378. The step of depositing the insulation layer 377 can be performed by any well known deposition technique, including sputtering, chemical vapor deposition (CVD), and the like.

Of course, it should be clear to one skilled in the art that other well known deposition techniques can also be used. For example, in some embodiments of the present invention, the insulation layer 198 can be applied to the substrate 110, the fiber 130 and the device 170 by spinning or spraying it on.

In some embodiments of the present invention, the module 100 can be fabricated without the insulation layer 198. In these embodiments, the step of depositing an insulation layer 370 is performed.

While embodiments of the present invention have been described in detail above, many changes to these embodiments may be made without departing from the true scope and teachings of the present invention. The present invention, therefore, is limited only as claimed below and the equivalents thereof.

What is claimed is:

1. A low signal loss optical module comprising:
a substrate having a channel;
an optical fiber having a core, wherein the optical fiber is received in the channel; and
an operational device positioned so to be in optical communication with the core.

2. The low signal loss module of claim 1, wherein the module is capable of transmitting a signal between the core and the operational device, such that any loss of signal power during transmission between the core and the operational device is low.

3. The low signal loss module of claim 1, wherein the operational device is in low signal loss optical communication with the core.

4. The low signal loss optical module of claim 1, wherein the operational device is capable of conditioning a signal carried by the optical fiber.

5. The low signal loss optical module of claim 1, wherein the operational device is an active device.

6. The low signal loss optical module of claim 1, wherein the operational device is a passive device.

7. The low signal loss optical module of claim 5, wherein the operational device is an electrooptical polymer.

8. The low signal loss optical module of claim 7, wherein the electrooptical polymer has a variable index of refraction, wherein the index of refraction is variable as a function of a voltage applied across the electrooptical polymer.

9. The low signal loss optical module of claim 6, wherein the operational device is a photopolymer.

10. The low signal loss optical module of claim 9, wherein the photopolymer comprises at least two sections separated by a distance, wherein the distance is defined so to limit passage of predefined wavelengths of light through the optical module.

11. The low signal loss optical module of claim 10, wherein each section of the photopolymer has a reflecting surface.

12. The low signal loss optical module of claim 1, further comprising an insulation layer positioned over the operational device.

13. The low signal loss optical module of claim 1, wherein the substrate has an upper surface, wherein the core has an upper section which is substantially aligned with the upper surface of the substrate and wherein the core is substantially aligned along the channel.

14. The low signal loss optical module of claim 1, wherein the optical fiber has a cladding positioned about at least a portion of the core, wherein a section of the core is exposed to allow optical communication between the core and the operational device.

15. A method of fabricating a low signal loss optical module comprising:
obtaining a substrate;
defining a channel in the substrate;
positioning a fiber in the channel, wherein the fiber has a core;
exposing the core of the fiber to create an exposed portion of the core; and
depositing an operational device, wherein the operational device is positioned so to be in optical communication with the exposed portion of the core.

16. The method of claim 15, wherein the method further comprises applying an insulation layer over the operational device.

17. The method of claim 15, wherein the operational device is a electrooptical polymer.

18. The method of claim 17, wherein the electrooptical polymer has a variable index of refraction, wherein the index of refraction is variable as a function of a voltage applied across the electrooptical polymer.

19. The method of claim 15, wherein the operational device is a photopolymer.

20. The method of claim 19, wherein the photopolymer comprises at least two sections separated a distance, wherein the distance is defined so to limit passage of predefined wavelengths of light through the optical module.

21. The method of claim 15, wherein defining the channel in the substrate comprises a photolithography and etching process.

22. The method of claim 15, wherein exposing the core of the fiber comprises a photolithography and etching process.

23. The method of claim 22, wherein the fiber further comprises a cladding positioned about the core and wherein exposing the core of the fiber comprises etching an upper portion of the cladding to expose an upper area of the core.

24. The method of claim 15, wherein positioning the fiber in the channel comprises aligning the fiber substantially with the channel and applying an adhesive to secure the fiber to the substrate.
